(19) United States
(12) Patent Application Publication
(10) Pub. No.: US 2012/0259891 A1
(43) Pub. Date: Oct. 11, 2012

(54) METHOD, SYSTEM AND PROGRAM FOR ANALYTICS DATA DELIVERING

(76) Inventor: David Edoja, Barnet (GB)

(21) Appl. No.: 13/526,530

(22) Filed: Jun. 19, 2012

Related U.S. Application Data
(63) Continuation-in-part of application No. 13/084,445, filed on Apr. 11, 2011.

(51) Int. Cl. G06F 17/30

(52) U.S. Cl. 707/784; 707/E17.005

(57) ABSTRACT

Provided are computer-implemented methods and computer systems for interactive data delivery to a user and for setting up a user profile. An interactive data delivery method involves retrieving generic data, which may be web analytics or some other forms of data, and processing this retrieved data based on various user specific rules. As such, the processed data provided to the user is more focused and has elements of business intelligence needed by a particular user. User requirements may depend on industry, business objectives, website objectives, the user's role in the organization, and other factors. Data may be requested and provided in an interactive form that includes voice recognition and voice output features.

### CROSS-REFERENCE TO RELATED APPLICATIONS

This application is a continuation-in-part of U.S. patent application Ser. No. 13/084,445, entitled “METHOD, SYSTEM AND PROGRAM FOR DATA DELIVERING USING CHATBOT”, filed on Apr. 11, 2011, which is incorporated herein by reference in its entirety.

### TECHNICAL FIELD

This disclosure relates generally to artificial intelligence dialog systems and, more specifically, to processing and interactive analytics data reporting.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Traditionally, business analytics has been used for the analysis of business performance. Business analytics may assist business owners or managers in gaining insight, business planning and understanding of business performance. Generally, business analytics data is based on statistical data and methods of such data arrangements. Business analytics data can help to answer questions such as what happened and how often, where is the problem, and what actions need to be taken. Business analytics can also answer questions such as why is this happening, what happens if the current trends continue, what will happen next, and how can performance be optimized.

Business analytics may refer to website analytics, sales analytics, financial services analytics, risk and credit analytics, marketing analytics, fraud analytics, pricing analytics, legal analytics, medical analytics, Information Technology (IT) analytics, transportation analytics, customer relationship management (CRM) analytics, competitive intelligence analytics, and so forth. In other words, business analytics data may relate to multiple different areas and generally requires special knowledge and skills to understand and manipulate such data.

Today's business market is saturated with business analytics data from online sources, CRM tools, web analytics tools, business intelligence sources, market intelligence sources, and so forth. The majority of business analytics tools available today for business owners are visualization tools. Such tools provide users with statistical data, graphs, charts, tables, and so forth that may be hard to understand for many business owners. In many instances, business owners or managers may find it difficult to correctly understand bulky statistical data and so may not take appropriate steps to address sales issues, marketing issues, website optimization (search engine optimization) issues, CRM issues, legal issues, and so forth.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented methods and computer systems for interactive data delivery to a user and for setting up a user profile. An interactive data delivery method involves retrieving generic data, which may be web analytics or some other forms of data, and processing this retrieved data based on various user specific rules. As such, the processed data provided to the user is more focused and has elements of business intelligence needed by this particular user. A user's requirements may depend on industry, business objectives, website objectives, the user's role in the organization, and other such factors. Data may be requested and provided in an interactive form that includes voice recognition and voice output features. In certain embodiments, interactive data delivery methods may be presented to a user in a dialogue form. Based on login information provided by a user, the system retrieves available information about this user. The user may also submit a request, or a set of predetermined requests may be already available in the system and may be retrieved based on the user login information. Regardless of the request source, the system may proceed with retrieving generic data associated with the request and processing this data based on information about this user. For example, the user login information may be associated with one or more scoring factors, which are used for classifying the retrieved data. Instead of burdening the user with all available data, the system presents only the data that is important to this particular user. The selection of data and form of presentation may vary greatly based on user's requirements.

In certain embodiments, a computer-implemented method for interactive data delivery involves receiving user login information and retrieving a user profile based on the user login information. The user profile may include information on the user's industry, user's company, user's role, business objectives, and/or the goal of the company's website. This information may be provided by the user during set up of a user profile, and/or by previous interactions with the systems, various plugins to databases (e.g., LinkedIn), and other sources of information. The method may proceed with receiving a user request for a certain type of information. For example, a user may choose a certain type of data or report to be displayed or otherwise communicated to the user. A user interface may display one or more reporting options from which a user can choose. These options may be preselected based on the user profile. In certain embodiments, one or more user requests may be automatically retrieved at the time of login into the system.

The method may proceed with retrieving generic data associated with the user request. The generic data may be retrieved from one or more web analytics services, such as Google Analytics®, Site Catalyst®, WebTrends®, GoodData®, NetStats®, and the like. The retrieved data may be web analytics data or some other data. In certain embodiments, a user profile includes information for login into the corresponding web analytics service. Overall, retrieving generic data may be performed using information contained in the user request and/or user profile. Once the generic data is retrieved or is otherwise available at the system (e.g., retrieved during some previous retrieval sessions), the method may proceed with processing the retrieved generic data to generate analytics data. The processing may be based on the user profile. The analytics data generated during this operation is specific to user-defined parameters. As such, even if the same generic data is retrieved for different users, the analytics data generated for these users will be different. One user (e.g., an executive) may be interested in an overview. Another user may be interested in a specific subset of the data specific to his or her job. Finally, the method may involve delivering the analytics data to the user. During this operation, the analytics data may be displayed on a user interface, provided in voice output, sent as a file or message to the user, and/or delivered according to some other methods.

In certain embodiments, processing the retrieved generic data to generate the analytics data involves fitting the retrieved generic data into one or more predetermined templates. This fitting operation may be based on one or more scoring factors associated with the user profile. For example, one user may be more interested in distinguishing between new visitors and returning visitors, counting a total number of visits, identifying unique visitors, determining time spent viewing a webpage, determining bouncing rate, determining the types of browsers used, determining operating systems, and/or other parameters. The one or more scoring factors may include a sale product category, leads generation category, provide information category, create online community category, sustaining current customers category, and/or recruiting affiliates category.

In certain embodiments, one or more values associated with the one or more scoring factors are selected based on the one or more data components of the user profile. A user may assign particular interest levels to various scoring factors listed above. Specifically, one user, such as publisher whose revenues are based on providing advertisement content, may be more interested in determining time spent viewing a webpage. Another user may be more interested in a number of followers and may be particularly interested in distinguishing between new visitors and returning visitors and/or counting the total number of visits.

In certain embodiments, processing the retrieved generic data to generate the analytics data involves fitting the retrieved generic data into one or more predetermined templates based on one or more key words received in the user request. For example, a user may input a particular text string that may be used to select a template or even to develop a new template for fitting the retrieved generic data. Such a text string may be providing by typing a string into a text field or by providing a corresponding voice command.

In certain embodiments, the computer-implemented method also involves transmitting a request to a remote data source based on the user login information and/or the user request and receiving a response from the remote data source containing the generic data. The remote data source may be one of the web analytics services listed above, a database, or some other source of data. The request transmitted to the remote data source may include authorization information in order for the remote data source to release the required information. For example, a user may have an account with one or more web analytics services. The computer-implemented method provided herein may be able to automatically login into these accounts (e.g., through a corresponding API) using information available to the computer system on which this method is implemented.

In certain embodiments, at least a part of the user request is received in a natural language format. A user may provide a voice input, which is then translated into corresponding commands. The natural language format enhances interactivity aspects of the computer-implemented method and may be easier to use than conventional type-and-read methods and systems. To implement the natural language format, the computer system may include a library of terms that may be used in such requests. In the same or other embodiments, at least a part of the analytics data is delivered in a natural language format.

The computer-implemented method may also involve repeating receiving a user request and delivering analytics data to the user. For example, a user may request different kinds of data or different presentation formats. In certain embodiments, these operations are repeated without retrieving additional generic data.

In certain embodiments, the computer-implemented method may also involve identifying abnormalities, incidents, or other events in the generic data and/or analytics data, and sending enquiries to specific users based on the one or more data components of the user profile (for example, a job title). If the users are aware of any information related to the identified abnormalities, they may provide such information, so the method will involve receiving user provided information. The user provided information may be delivered to other users based on the analytics data they are delivered. For example, the user provided information associated with a specific incident may be provided to the users whose analytics data include data related to the incident. Additionally, while determining which users will receive the user provided information, date ranges related to abnormalities, incidents, or other events and to the user provided information may be considered.

Provided also is a computer-implemented method for setting up a user profile. In certain embodiments, the method may involve receiving user login information and obtaining one or more data components, such as user industry, company, user role, business objective, and/or website goal. Other types of data may be used as well. The method also involves associating the user login information with these data components. In certain embodiments, the method involves obtaining one or more scoring factors for the one or more data components associated with the user login information. Each of the one or more scoring factors may represent an importance of the corresponding data component of the one or more data components to the user. In certain embodiments, the computer-implemented method also involves receiving one or more pointers for retrieving generic data and associating the login information with the one or more pointers. The method may also involve generating one or more reporting templates for presenting retrieved generic data, with the one or more reporting templates generated based on the one or more scoring factors.

Provided also is a system for interactive data delivery. The system includes one or more processors and one or more subsystems to receive user login information, retrieve a user profile based on the user login information, receive a user request, and retrieve generic data associated with the user request. The same or other subsystems may process the retrieved generic data to generate analytics data, with the processing being based on the user profile, and a subsystem to deliver the analytics data to the user. The overall system may also include a memory coupled to the one or more processors to store computer-executable instructions. In certain embodiments, the one or more processors are further configured to fit the retrieved generic data into one or more templates. This fitting may be performed based one or more scoring factors associated with the user profile. Examples of scoring factors include a sell product category, leads generation category, provide information category, create online community category, sustaining current customers category, and recruiting affiliates category. In certain embodiments, the system also includes at least one subsystem for transmitting a request to a remote data source based on the user login information and/or the user request and for receiving a response from the remote data source containing the generic data. The system may also include at least one subsystem to receive and process at least a part of the user request received in a natural language format.

Provided is a computer-readable medium including instructions, which when executed by one or more computers, perform operations, such as receiving user login information and, based on the user login information, retrieving a user profile including one or more data components. Examples of such data components include user industry, user company, user role, business objective, and website goal. Instructions included on the computer-readable medium may correspond to receiving a user request, retrieving generic data associated with the user request, processing the retrieved generic data to generate analytics data, and delivering the analytics data to the user.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a computing environment, within which a Virtual Analyst Platform can be implemented, in accordance with one example embodiment.

FIG. 2A is a block diagram illustrating the Virtual Analyst Platform, in accordance with an example embodiment.

FIG. 2B is a block diagram illustrating the Virtual Analyst Platform, in accordance with different embodiments.

FIG. 2C is a schematic representation of the Virtual Analyst Platform architecture, in accordance with certain embodiments.

FIG. 3A is a process flow diagram illustrating a method for interactive data delivery, in accordance with an example embodiment.

FIG. 3B is a process flow diagram illustrating a method for interactive data delivery, in accordance with different embodiments.

FIG. 3C is a process flow diagram illustrating a method for setting up a user profile, in accordance with different embodiments.

FIG. 4 is a process flow diagram illustrating a further method for interactive data delivery, in accordance with different embodiments.

FIG. 5 is a Virtual Analyst chat interface, according to an example embodiment.

FIG. 6 is a diagrammatic representation of an example machine in the form of a computer system within which a set of instructions, for causing the machine to perform any one or more of the methodologies discussed herein, are executed.

FIGS. 7A-7D are examples of different user interface presented on a mobile device during interaction with the analytics system, in accordance with certain embodiments.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein can be implemented by various means depending upon the application. For example, embodiments can be implemented in hardware, firmware, software, or a combination thereof. For a hardware implementation, embodiments can be implemented with processors, controllers, micro-controllers, microprocessors, electronic devices, other electronic units designed to perform the functions described herein, or a combination thereof. Memory can be implemented within the processor or external to the processor. As used herein, the term “memory” refers to any type of long term, short term, volatile, nonvolatile, or other storage device and is not to be limited to any particular type of memory or number of memories, or type of media upon which memory is stored. For a firmware and/or software implementation, embodiments can be implemented with modules such as procedures, functions, and so on, that perform the functions described herein. Any machine-readable medium tangibly embodying instructions can be used in implementing the embodiments described herein.

Embodiments disclosed herein relate to artificial intelligence dialog systems for interactive data delivery. A dialog system, as used herein, is a computer system intended to provide customer service or other assistance via a website by receiving a user request in a natural language format, converting the request into a machine-readable form, processing the request, and responding to the request by delivering the requested information in a natural language format.

According to embodiments disclosed herein, data to be delivered via a dialog system may relate to multiple business fields such as website analytics data, sales analytics data, CRM data, business intelligence data, competitive intelligence data, financial services analytics, risk and credit analytics, marketing analytics, fraud analytics, pricing analytics, legal analytics, medical analytics, IT analytics, transportation analytics, and so forth.

The system may be specifically configured to deliver business intelligence data, with web analytics being a specific example of such data. In order to deliver business intelligence having substantial value to users, the system focuses on providing users with insight and context on the provided data as opposed to provide just the data.

To provide content for the data, the system may include a data warehouse containing a relational database for an online analytical processing cube to store information relating to industries, web site goals, and company news. These types of data may be used to make up the context delivered to the user. At the same time, a rules engine of the system may be configured to score metrics for analyses based on set KPIs for each individual company, the metrics being the industry, website goals, and the like. These metrics may then be used to determine the level of insight given to each user group, e.g., management, team leads, and analysts. For example, users in the management group can be given summarized analyses focusing on top level KPIs, context and insight, while users in the team lead groups can be given more analyses focused on their KPIs with context and insight. Continuing with this example, users in the analyst group can be provided with additional details in the analyses on KPIs with context and insight but also guided to other metrics that provide more insight.

Below is provided an embodiment related to the delivery of web analytics data. Although this embodiment is directed to web analytics data, it shall not be understood as a limitation, and those skilled in the art would understand that any possible data can be used.

Website analytics is generally used for the measurement, collection, analysis, and reporting of website usage data and website visitor behaviors for the purpose of understanding and optimizing website usage. Website analytics can measure and analyze performance of a website in commercial as well as non-commercial contexts. In a commercial context, a website owner may want to know which pages of the website encourage people to make a purchase. The data collected during performance measurements of the website can be used to improve website effectiveness.

In website analytics, various approaches can be taken to collect and process data related to website performance. According to one approach, log files in which the web server records its transactions can be read and analyzed. In another approach, pages of the website can be tagged with a snippet of computer code (e.g., JavaScript or an image) to notify a third-party server when the pages are rendered by the web browser. The snippet can also pass certain information about the webpage and the visitor to the third-party server. This information can then be processed and appropriate statistics generated. The statistics can then be used to provide reports, which can include website performance information, number of page views, time of the day, cursor movement data, and click data (e.g., location on the page, object clicked on, and other custom metrics).

Web analytics services and other similar data aggregators and databases can provide much generic data that is hard to understand for a typical user of such data. Companies often hire web analytics professionals to make sense of this generic data. For example, a publishing company and professional or social networking company may have similar websites with similar levels of web traffic. However, the type of information these companies are interested in is quite different. A generic number of hits during a particular period may be helpful but does not reflect the context of the specific business. In this example, the publishing company may be interested in duration of visits and particular click streams. The publishing company may generate its revenues from banner ads and the above referenced factors may be important for this revenue generation model. On the other hand, the networking company may be more concerned with new leads and users. Its metrics may involve differentiating between new and returning users, identifying unique users, determining languages used by the users, and other like factors. While web analytics systems generate lots of generic data, which is useful, this data cannot be easily understood and interpreted by the user. The generic data is simply not as useful as data presented in specific context, such as user industry, user company, user role with the industry and/or the company, business objectives, and website goals, just to name a few.

Provided are computer-implemented methods and computer systems for interactive data delivery to a user based on various user specific information available to the system. Also provided are computer-implemented methods and computer systems for populating the system with this user specific information (for example, setting up a user profile containing such information). The system is configured to sort and present this specific information based on the user specific information, thereby making this information more understandable and more useful to the user. The computer-implemented methods and computer systems also allow using various interactive data inputs and/or outputs, which may be based on voice recognition technologies.

An interactive data delivery method involves retrieving generic data, which may be web analytics or some other forms of data, and processing this retrieved data based on various user specific rules. As such, the processed data provided to the user is more focused and has elements of business intelligence needed by this particular user. A user's requirements may depend on industry, business objectives, website objectives, user's role in the organization, and other such factors. Data may be requested and provided in an interactive form that includes voice recognition and voice output features.

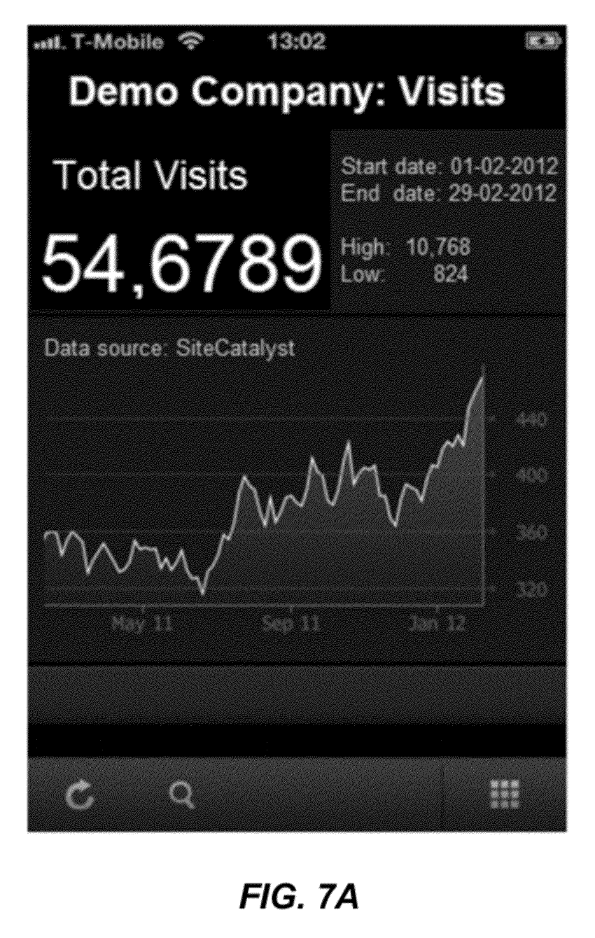

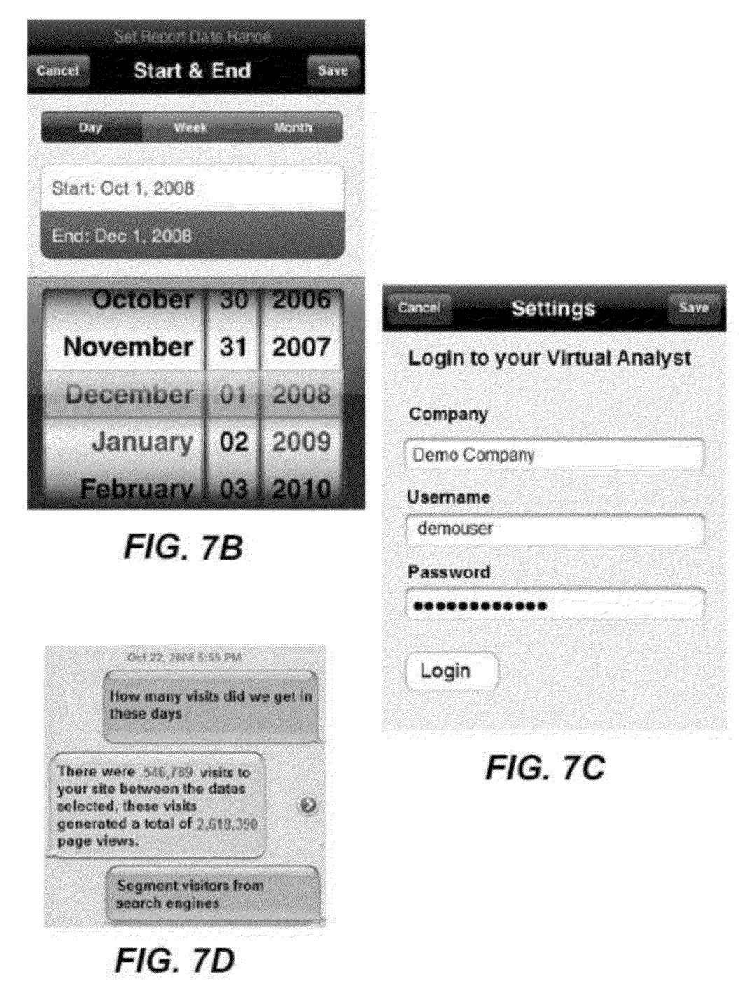

A brief description of the system will now be provided. In certain embodiments, the system includes two main components: an Analytics Intelligence Engine (AIE) and a Virtual Analyst Interface (VAI). The AIE is built upon an artificial intelligence system for delivery of support services through smart agents. It is made up of a combination of various modular systems as further presented and explained below. The design architecture of the AIE places great emphasis on the separation of function. As a result, the architecture takes a layered approach. The AIE uses a unique combination of algorithms and rules for the calculation and extraction of client data for multi-dimensional metrics analysis and dynamic data segmentation. For example, the AIE may take into account company information, such as a company's business objectives, website goals, and industry. In certain embodiments, it also takes into account the individual user's job role to ensure the response provided by the ultimate user output is suited for their job functions and the level of detail that may be needed. The AIE may be an object oriented application that can be utilized behind a web page, mobile device application, or other client devices, letting users interact with it through natural language processing with speaking avatars, as further explained below. In certain embodiments, the AIE is a mobile device application operable on iOS, Droid OS, or any other mobile device operating system. The mobile device application may be designed to provide simple interactions between users and the system where users send questions from a mobile application interface to a server. The questions may be sent in a variety of formats, such as SMS messages or voice signals. The system can reply with analyses responses and graphs in the same (e.g., SMS or voice) or different format back to the mobile application for rendering on a user interface. FIGS. 7A-7D are examples of different user interface presented on a mobile device during interactions with the analytics system, in accordance with certain embodiments.

Speech recognition is also being developed into the mobile applications enabling users to simply say their commands or ask questions. In response, the application may compress what's been said sending it to one or more servers for recognition and analysis. After processing the questions responses can be encrypted, compressed and sent back to the mobile application which may have a built in text to speech engine to say the responses back to the user.

The VAI is the primary interface to the AIE from the user perspective. It is a smart agent application, which uses machine-learning rules to customize its reports for each client based on their stored information, such as business objectives, website goals, and reporting requirements. Other types of information are described further below. In certain embodiments, each client account is assigned an avatar, which may use natural language processing for speaking and interacting with users. As such, users may talk to their computer interfaces instead of continuously typing data in the corresponding field. In specific embodiments, the integration of a voice recognition system as part of the platforms architecture also supports a voice driven mobile application interface.

The VAI may be constructed based on the Microsoft C# environment or based on the Microsoft .NET environment and will be exposed to other applications via both an object model and a web service. This dual exposure provides additional flexibility for the implementation on client devices. In specific embodiments, the VAI interface is implemented on an asp.NET web page using standard HTML and JavaScript as well as C# code. Calls from the AIE platform to the VAI are achieved using Asynchronous JavaScript and XML (AJAX) calls back to the same page on the server, thus allowing the page to be updated with speech, text, and graph outputs without a full visible post-back. In the event that the client is using a browser that is not AJAX compatible, an alternative page will be displayed that allows the use of the avatar in a traditional “IFrames” implementation. This page may offer the same conversational capabilities as the AJAX enabled page, but will use traditional “post-backs” to send and retrieve the information.

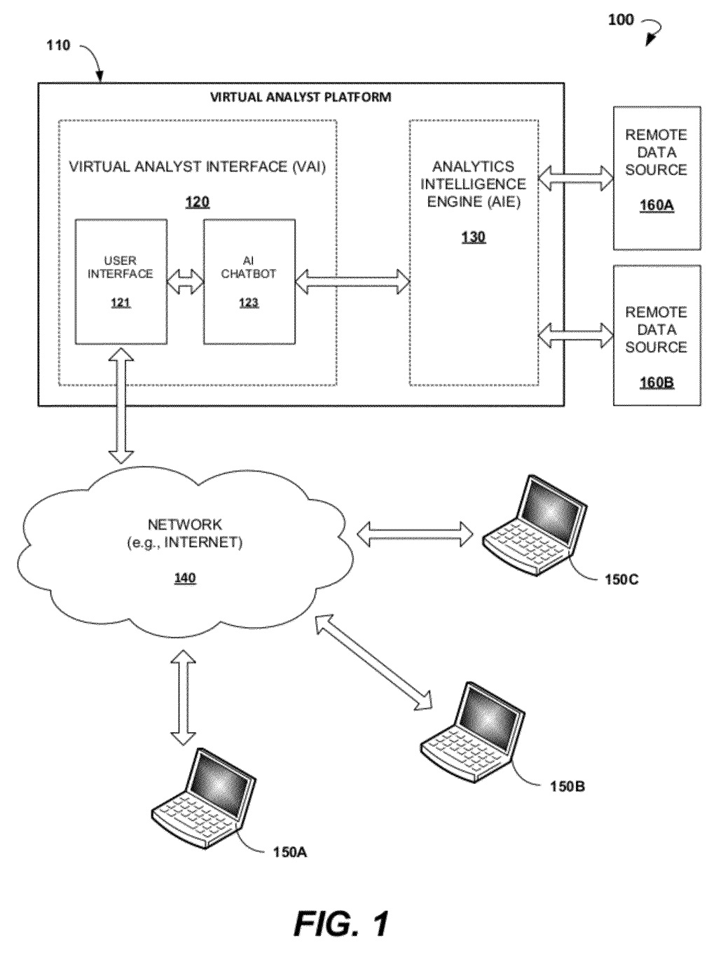

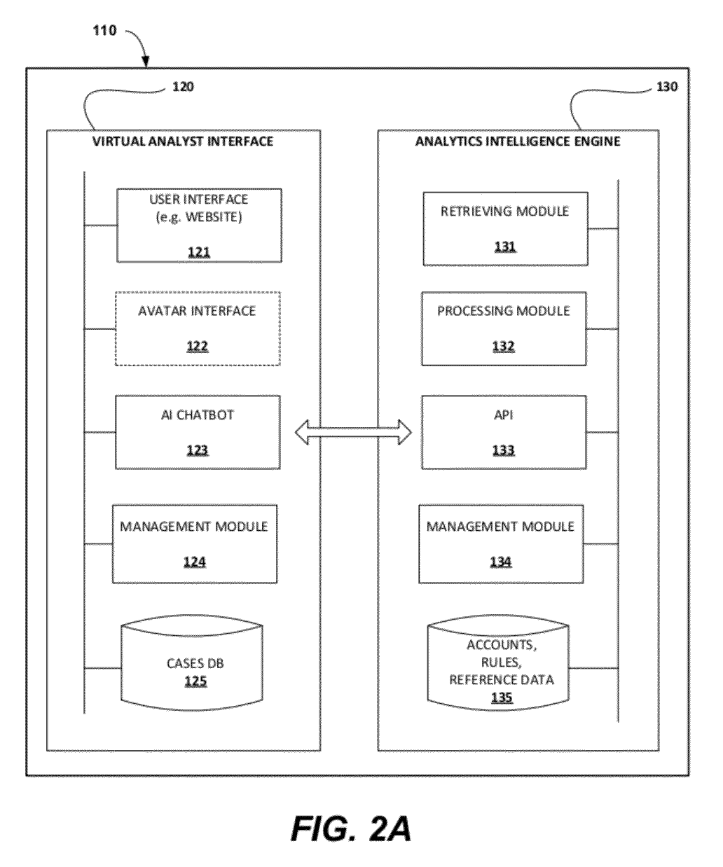

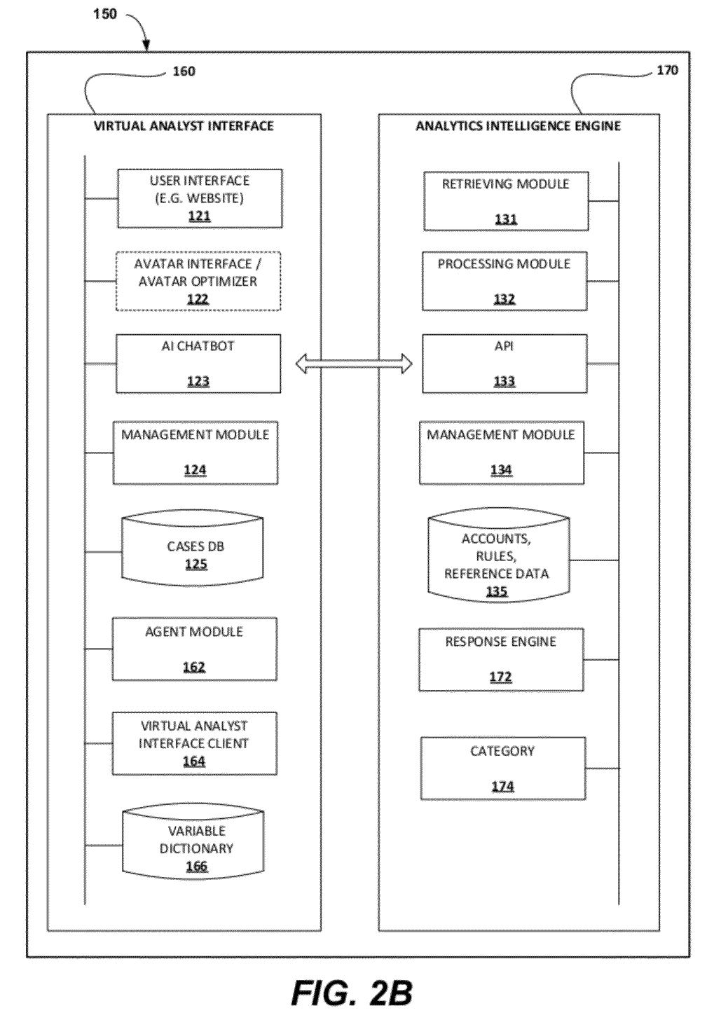

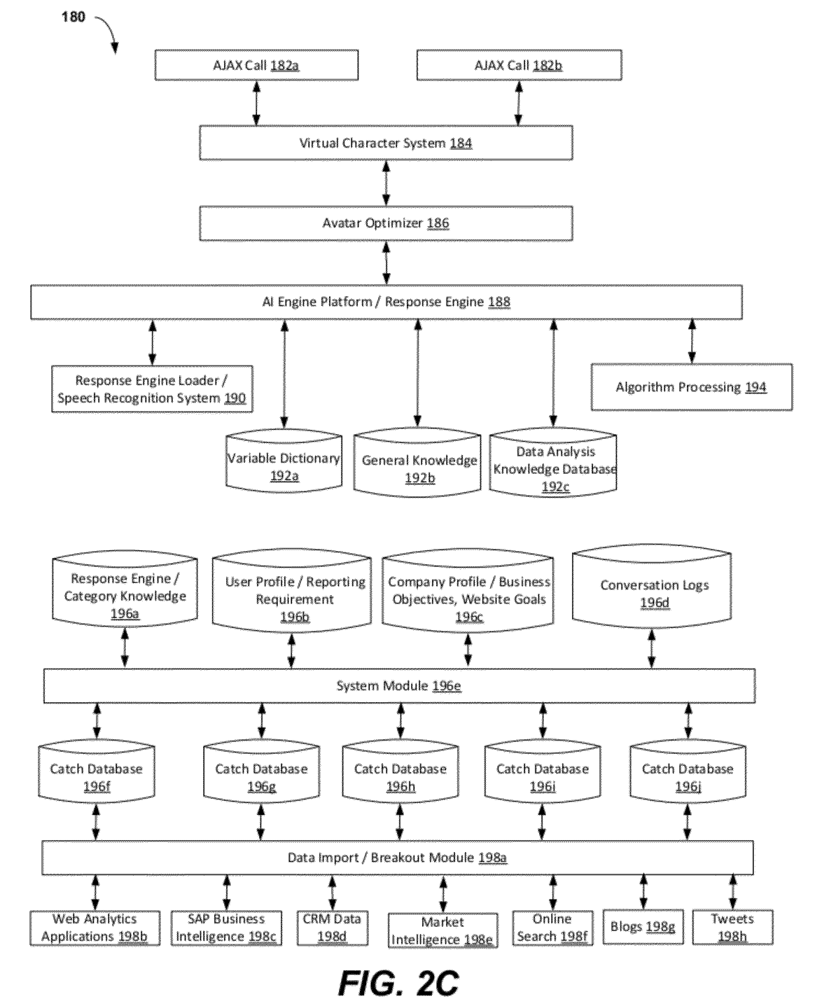

Referring now to the drawings, FIG. 1 illustrates an example of computing environment 100, within which a Virtual Analyst Platform can be implemented. The Virtual Analyst Platform can be considered as an integrated web platform (application) 110 configured to access, process, and communicate data such as web statistics data, web analytics data, CRM data, business intelligence data, competitive intelligence data, and any other form of business data. The web platform 110 can be embedded into one or more web servers, and may include a VAI 120 and an AIE 130, which will be described in detail below with reference to FIG. 2A. The web platform 110 can be accessed by users via a network 140, such as the Internet.

The embodiment shown in FIG. 1 can be implemented in a client-server environment. The Internet is one example of a client-server environment. However, any other appropriate type of client-server environment, such as an intranet, a wireless network, a telephone network, a cellular network, and the like, or a combination thereof, may also be used. This disclosure, however, is not limited to the client-server model and could be implemented using any other appropriate model.

The users may access the web platform 110 via terminals 150A, 150B, and 150C. As used herein, the term “terminal” refers to a computer, a mobile device, a handheld cellular phone, a smart phone, user equipment, a portable communication device, a portable computing device, a personal digital assistant (PDA), a tablet personal computer, or some other electronic device with the ability to receive and transmit data via a wired or wireless network. In some embodiments, the terminals 150A-150C may be provided with the ability to browse and/or interact with websites on the Internet, thereby allowing users to communicate with the web platform 110. In some embodiments, the terminals 150A-150C may embed proprietary software for communicating with the web platform 110. For example, the terminals may embed software for communicating in the way of real-time direct text-based communication (such as Instant Messaging, chats), audio/video based communication, telephone messages, e-mails, and so forth.

The VAI 120, as a part of the integrated web platform 110, may be provided with a user interface 121 configured to provide communication with users. In some embodiments, the user interface 121 is a website that can be accessed via the Internet. According to other embodiments, the user interface 121 may be implemented as software for communicating data with user terminals 150A-150C in the way of instant messages (IM), telephone messages (e.g., SMS, MMS), e-mails, blog postings, social media messages such as tweets, and so forth.

According to various embodiments disclosed herein, the Virtual Analyst Interface 120 comprises an Artificial Intelligence (AI) chatbot 123. As used herein, the term “chatbot” refers to a computer program configured to simulate an intelligent conversation with users via voice, images, video and/or text on an Instant Message (IM) basis. Such programs are sometimes referred to as Artificial Conversational Entities, talk bots, or chatterbots. In other words, chatbots may provide users with text-to-speech and speech recognition functions such that users may interact with a chatbot similarly as in communication with a real person. The chatbot may therefore recognize a user's speech, convert it into machine-readable form, process user requests, and deliver corresponding responses as spoken language. According to another embodiment, the chatbot may receive alphanumerical user input instead of using a speech recognition function. Studies performed have shown that people process information better and avoid misinterpretations if the information is presented via the chatbot. The AI chatbot 123 is described in more details below with reference to FIG. 2A.

In certain embodiments, the chatbot 123 may be integrated into the user interface 121 or, more specifically, the user interface 121 may include all or most functions of the chatbot 123 described in this document. This integrated system may be referred to as a user interaction system and may be itself integrated into the AI Engine architecture.

This user interaction system may be a part of the platform's artificial intelligence system developed as the core for the AI Engine. The user interaction system may use keywords and phrases recognition to identify what a user types or says, as further described below with reference to the speech recognition functionality. This information is then used to generate one or more queries corresponding to the user's request. The user interaction system may not include avatars as a representation of the virtual analyst.

The AIE 130 is a part of the integrated web platform 110, which may be used for retrieving and processing data such as web statistics data. Web statistics data may be retrieved from remote data sources 160A, 160B. Although there are two remote data sources 160A, 160B shown in FIG. 1, for those who are skilled in the art, it is understood that any number of such sources can be accessed by the web platform 110. According to an example embodiment, the remote data source 160A or 160B is a remote web statistic system such as Google Analytics®, Site Catalyst®, WebTrends®, GoodData®, NetStats®, or the like. According to another example embodiment, the remote data source 160A or 160B is an Internet-based search engine such as Google®, Yahoo®, Bing®, and the like. Those who are skilled in the art would understand that any remote data source, public or private, can be used. The AIE 130 may communicate with the remote data sources 160A, 160B directly (as shown), or via the network 140.

As used herein, the term “web statistics data” refers to a number of visits, hits, amount of received/transmitted data, number of viewed pages, session duration, active time, engagement time, number of unique visitors/new visitors/repeated visitors, number of errors, exit percentage, page depth, page viewers per session, clicks, click path, heat mapping, and the like. Web statistic data can be gathered by remote data sources 160A, 160B using any known methods, such as log file analysis, page tagging, or other methods.

FIG. 2A is a block diagram illustrating the Virtual Analyst Platform 110. As mentioned, the integrated web platform 110 includes the VAI 120 and the AIE 130. In one example embodiment, the VAI 120 may include the user interface 121, which can be implemented as a website or software configured to interact with a user. The user interface 121 may receive a user's input in alphanumerical form, speech form, or mouse clicks, and may deliver data to the user via visual, audio (voice), and/or text form.

In one embodiment, the VAI 120 may optionally comprise an avatar interface 122 for simulating the appearance of a person delivering the speech. According to one embodiment, an avatar engine is remotely located, while the VAI 120 is provided with an application (the avatar interface 122) for accessing or generating a corresponding avatar representation. According to another embodiment, the avatar interface 122 embedded in the VAI 120 may serve as the avatar engine for accessing and generating a corresponding avatar representation. In example embodiments, an avatar appearance can be selected by a user before requesting that the web platform report analytics data. The user may also select different avatars for delivering different types of analytics data.

The VAI 120 further includes the AI chatbot 123 serving to convert and process received user input into machine-readable form. In one embodiment, the AI chatbot 123 receives a user's text or speech command in the natural language format and parses this command. For this purpose, the AI chatbot 123 may comprise (or access from a remotely located system) a speech recognition system (not shown). For example, Dragon Natural Speaking speech recognition software available from Nuance in Burlington, Mass. may be used on a server side and/or a user device side. The system may have a module with a library of words and phrases relating to business intelligence, web analytics, online marketing and general reporting terms that can be used by users in asking the system questions.

For example, the user may give a command in the way of saying “Okay,” “Go ahead,” “Continue,” or the like to order the integrated web platform 110 to execute a corresponding action. Such commands can be recognized by the AI chatbot 123, and all of these commands should be interpreted in a single form. As explained above, AI chatbot 123 may be integrated or replaced with a user interaction system.

In another embodiment, the user may input an alphanumerical command to be parsed by the AI chatbot 123. In yet another embodiment, the user may press/click buttons, click targets/links, or the like, which are provided to the user to instruct the web platform to deliver a specific data.

According to an example embodiment, the chatbot engine may be remotely located, and the VAI 120 may possess a corresponding application to address the remote chatbot engine. Otherwise, the VAI 120 may comprise the chatbot engine to perform the functions described herein.

The VAI 120 may also include a management module 124 configured to manage the user interface 121, the avatar interface 122 (if any), the AI chatbot 123, and a cases database 125. The management module 124 may comprise rules for treating user requests/commands, retrieving, analyzing and delivering data, identifying and selecting cases, merging responses, and the like.

When the AI chatbot 123 semantically recognizes the user's command, the management module 124 proceeds to identify the best matching “case” (an input-response dialogue pair). The cases can be stored in the cases database 125. Multiple different cases can be provided to address multiple needs for delivering information to the users. Each case is provided with one or more template responses. For example, if the user's command is interpreted as “number of visits for today” related to the user's website, the case may have a template response of “The number of visits is . . . .” This response is then accomplished with corresponding data retrieved from the AIE 130, as will be described below. Thereafter, the response is reported to the user via the user interface 121 using the avatar simulation speech, text or image/video output, or the like. In some embodiments, the response output may comprise links to external sources of information (e.g., texts, images, graphs, tables, videos, audios, links, and so forth).

To retrieve data from the AIE 130, the AI chatbot 123 generates and communicates one or more API calls to the AIE 130 in accordance with an identified case. The AIE 130 processes the API calls of the AI chatbot 123 and returns a corresponding response. This response can then be merged with the case template response and delivered to the user.

The AIE 130 is a core artificial intelligence driven analytics system. The AIE 130 comprises a retrieving module 131 configured to access remote data sources, such as sources 160A, 160B shown in FIG. 1 (e.g., remote web statistic systems), and retrieve corresponding data from them. The retrieving module 131 is configured to access APIs of remote data sources to retrieve corresponding data. The retrieved data may be optionally stored in the database 135 for further use.

The AIE 130 may also comprise a processing module 132. The processing module 132 is configured to generate a semantic model and process generic data retrieved by the retrieving module 131 and generate analytics data (e.g., web analytics data) according to multiple rules and reference data stored in the database 135. The processing of generic data (e.g., web statistics data) relative to a user's request may include a comparison of the retrieved generic data to benchmark data, segmentation of the retrieved generic data, evaluation of metrics for the segments of the generic data, and subsequent generation of the analytics data (e.g., website analytics data).

In one example related to web analytics, segmentation derived from the web statistics data may involve a number of viewed pages, number of hits, a bandwidth, files downloaded, IP geo locations, Visit/Visitor/Page referrer, new vs. returning visitor, paid vs. organic search referred, visitor frequency, buyers vs. non-buyers, new vs. repeated buyers, purchase frequency, screen resolution, browser type, operating system type, marketing campaigns seen, or the like.

According to one example, the semantic model generated by the processing module 132 may be associated with the generic data and include concepts retrieved from the remote data sources and an ontology (relationship and history of the concepts). The semantic model may also be associated with the user request, and specifically with an input-response dialogue pair. The semantic data may also be associated with a set of rules stored in the database 135. The set of rules can be selected based on specific concepts, an ontology, or an input-response dialogue pair to address specific request of the user relative to the user's objectives, goals, and reporting requirements. Accordingly, the retrieved generic data is processed by the processing module 132 against a set of rules selected by the semantic model.

Thus, processing of the generic data and generating analytics data is conducted according to a specific command of the user with reference to rules stored in the database 135.

The AIE 130 further comprises an API 133 configured to receive API calls from the AI chatbot 123 and instruct the modules of AIE 130 to conduct a corresponding action. In one example, received API calls are converted into codes accessible by specific implementation of the AIE 130 (for example, into XML codes, Perl codes, C# codes, .NET codes, etc.) and transmitted to a management module 134. The management module 134 is configured to manage all modules comprised in the AIE 130. In particular, upon receipt of the command from the API 133 associated with API calls (in turn, received from the VAI 120), the management module 134 may retrieve a corresponding rule set and service data (such as user account data, reference data, etc.) from the database 135 to request the retrieving module 131 to retrieve corresponding data, generate a semantic model, and process data according to the selected rule set and the semantic model. Processed data (i.e., analytics data, such as web analytics data) is then returned to API 133 to communicate to the VAI 120 via the AI chatbot 123.

FIG. 2B is a block diagram illustrating Virtual Analyst Platform 150, in accordance with different embodiments. Some components of the Virtual Analyst Platform 150 are the same as described above with reference to FIG. 2A. The Virtual Analyst Platform 150 also includes the VAI 160 and AIE 170. The VAI 160 may have one or more new modules relative to the VAI described above with reference to FIG. 2A. In certain embodiments, these modules or functions of these modules may be integrated or otherwise provided by the modules of the VAI described above with reference to FIG. 2A. Likewise, The AIE 170 may have one or more new modules relative to the AIE described above with reference to FIG. 2A. In certain embodiments, these modules or functions of these modules may be integrated or otherwise provided by the modules of the AIE described above with reference to FIG. 2A.

The VAI 160 is shown to include the agent module 162, virtual analyst interface client 164, and variable dictionary 166. The agent module 162 may provide the primary interface to the end-user client. For example, the agent module 162 may be used to execute a RespondTo( . . . ) function. In certain embodiments, the agent module 162 is integrated into the user interface 121 or some other module described above. The virtual analyst interface client 164 may be fully configurable via the asp.NET, such as a web.config file. However, other configurations may be used as well. In certain embodiments, the VAI 160 may include a response engine, which may be an object used to parse and respond to the input provided by the user. In the same or other embodiments, the VAI 160 may include an avatar optimization engine, which may be an object used to optimize the response from the response engine to the specific requirements of the avatar being used. One of the modules of the VAI 160 (e.g., a client interface module or one of the modules shown in FIGS. 2A or 2B) may be used to hold client specific information between calls to the agent. This module may also be responsible for providing information to a cookie that can be passed to the caller and loading that information back from the cookie where it already exists.

The AIE 170 is shown to include a response engine 172, which may be used to provide the main request/response processing, give responses to the input requests from the user, and other functions. In certain embodiments, the response engine 172 is configurable via the asp.NET web.config file.

The system may include chatbot-predicates, which are standard variables that the chatbot should know. The same approach may be used by a user interaction system that may replace the chatbot. The system may also include an abusive word list, which is a path (fixed or relative) to an XML file containing a list of words considered abusive. If one or more of such words are detected in a user's request, the system may be configured to cease responding. In certain embodiments, the system includes knowledge base sources, which is a list of the various sources where knowledge base information is stored. These sources may also include objects required to be instantiated in order to load them.

The response engine 172 may be configured to respond to the user request by passing the request to each of the category objects loaded (irrespective of native type) and recording the score returned. In certain embodiments, the top five matches are maintained throughout the search, thus allowing additional logic to be added at a later date. This feature may be used to determine whether the answer is being repeated and then substitute an alternative answer if appropriate.

The AIE 170 is shown to include a category module 174, which may be a base module representing an individual case within the knowledge base. The category module 174 may provide the various implementations, such as a response and scope. The response may include the Artificial Intelligence Markup Language (AIML) template that will be processed when this implementation is selected. The score provides functionality to determine the quality of the match with the request. The category module 174 may include various sub-modules, such as an AIML-Category that represents cases specified in AIML format (e.g., version 1.0.1). Pattern matching may be based upon given rules. The AIMPL-Category accepts the AIML <Topic>, <Pattern> and <Template> values and provides a custom implementation of the score method. Another sub-module in the category module 174 may be Keyword-Category, which represents cases to be identified using keywords. Other sub-modules in the category module 174 may be RdfTriple-Category, which represent cases to be retrieved as RDF/Triple(s), and Category-Match, which represents the match information for each case. The Category-Match may include scoring and the various matches to wildcard characters. This information can then be passed along with the AIML <template> to build the correct response for the user.

In certain embodiments, Virtual Analyst Platform 150 also includes a Category Match Collection, which is a collection of Category Match objects that are used to maintain a list of the top x matches to the knowledge base categories and allowing only the topmost-scored answer to be selected, if desired. Another component of the Virtual Analyst Platform 150 may be an Avatar Optimizer, which is a base module representing optimization routines for the various avatars that could front this service. The Avatar Optimizer module is further divided into the following modules representing each of the avatars. One example of these modules includes Site Pal Avatar Optimizer, which may provide customization of the output from the response engine to suit the Site Pal avatars. Optimization will consist of word conversions to assist in the proper pronunciation of words. Another example is configuration (support object), which is a generic loader for .config file sections that simply returns the XML node from the .config file back to the calling function. The configuration module also provides some generic functionality for the dynamic creation of objects and mapping of files. Yet another example is Response Engine Loader (support object), which is a base module representing a “loader” for the various types of category.

The Response Engine Loader module may be divided into the following sub-modules representing the different Category types and data sources for loading. One sub-module may be an AIML Loader for loading AIML cases from an XML file into the Response Engine 172 and thereby creating individual AIML Category objects for each case. Another sub-module may be Keyword Loader for loading Keyword cases. Various sources for these cases may be used. Yet another sub-module is RDF Triple Loader for loading RDF/Triple cases. Again, various sources for these cases may be used.

As shown in FIG. 2B, the system also includes the variable dictionary 166 containing support objects. This is a generic dictionary used to hold variables at both the smart agent level (predicates) and at the Virtual Analyst interface level (get/set). The system may include an administration application (not shown), which may be a standard asp.NET web application facilitating the editing of the “case” information, such as AIML, keyword, and RDF/Triple. In certain embodiments, the administrative application is used for displaying listings of conversations carried out with the virtual analyst and for further exploring the individual inputs and outputs that made up that conversation. The application may include a home page, which may be used for authentication and presenting the user with options for administering the system, and view conversation logs, which may present a list of the conversations in date/time order. Filtering may be available to restrict the list to entries between specified date-time combinations. The application may also present view conversation log details. This page may present a list of each exchange that took place during the conversation (for example, an exchange representing both the user input and the reply given). Furthermore, the view knowledgebase may be in a form of a page for presenting a summary of the cases that are present within a selected knowledgebase file. Upon entry to the page, the user may be prompted to select a knowledgebase file from the application folder hierarchy.

The system may also include edit knowledgebase case, which may be a page presenting the user with the details of a specific knowledgebase case and allowing the user to change those details. This feature may include multiple pages, with each page being specifically targeted at the type of case being edited (AIML/keyword/RDF, etc.). Other components of the system may be various data storages, knowledge bases, and conversation logs. The knowledge bases may be stored in XML files located within the application folder hierarchy. In the same or other embodiments, the knowledge bases can be also stored in the SQL Server database. The conversations may be stored in an SQL Server database table with each conversation being identifiable by a unique Globally unique identifier (GUID) created at the beginning of each session. Each entry within the conversation may be sequenced by the date and time of the exchange, therefore allowing the conversation to be read as it happened. Another component of the system may be error logs, which may be initially stored in text files within the application folder hierarchy.

A call module may be configured to return the minimum possible text. For example, it may return a numeric value corresponding to a specific metric (e.g., returning a number “325757” corresponding to page views in a specified period). In certain embodiments, if a response involves a certain dynamic comparison or multiple values, then the API will return the whole phrase fragment (e.g., “325757, which represents a 20% increase on the previous month”).

In certain embodiments, the system also includes a breakout module to include the return of multiple parameters. These parameters may give the Virtual Analyst system more flexibility in how to represent returned data and remove the need to store phrase fragments in the proxy. If there is an error in getting the data, the proxy may return a “not retrieved” message, sometimes with additional error information.

Various modules described above may be arranged according to various system architectures. FIG. 2C is a schematic representation of the Virtual Analyst Platform architecture, in accordance with certain embodiments.

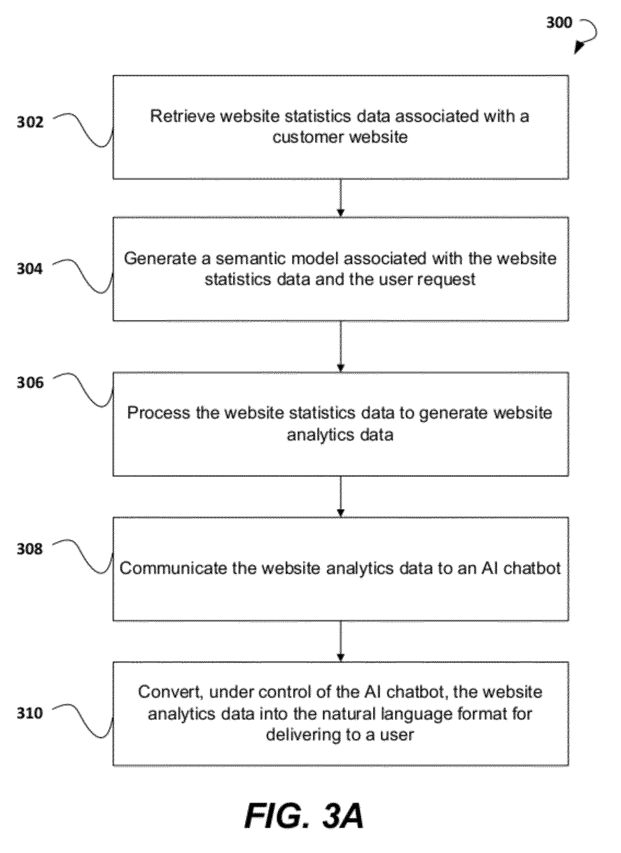

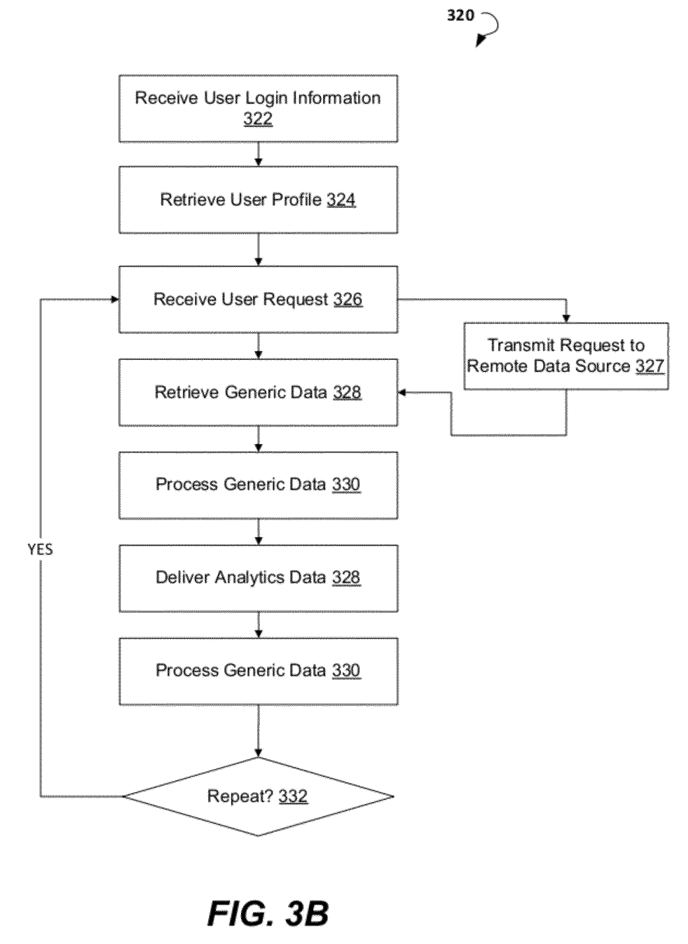

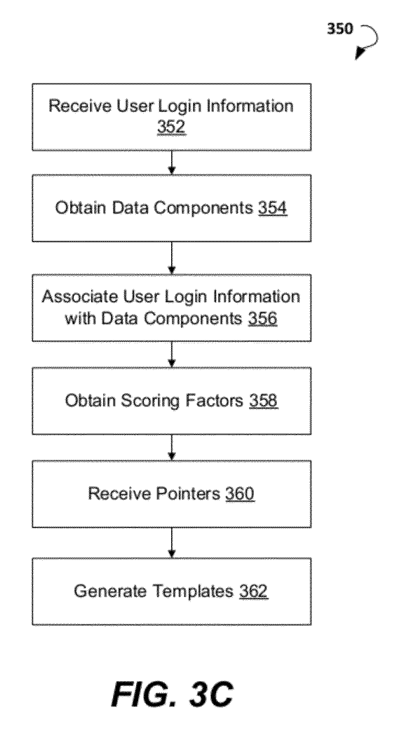

FIG. 3A is a process flow diagram illustrating a method 300 for the interactive delivering of website analytics data, in accordance with an example embodiment. The method 300 can be performed by processing logic that can comprise hardware (e.g., dedicated logic, programmable logic, and microcode), software (such as software run on a general-purpose computer system or a dedicated machine), or a combination of both. In one example embodiment, the processing logic resides at the web platform 110, illustrated in FIG. 1. The method 300 can be performed by the various modules discussed above with reference to FIGS. 2A and 2B. Each of these modules can comprise processing logic.

As shown in FIG. 3A, the method 300 can commence at operation 302 with the AIE 130 retrieving generic data such as web statistic data related to the usage of a customer website. As mentioned, the website statistics data can be retrieved by the retrieving module 131 directly from a remote web statistic system or via a network.

In operation 304, the AIE 130, and in particular the processing module 132 or, alternatively, the management module 134, generates a semantic model associated with the generic data and the user request related to the website usage

In operation 306, the AIE 130, and in particular the processing module 132, processes the website statistics data to generate website analytics data. The processing may include a comparison of the retrieved website statistics data to benchmark data, segmentation of the retrieved website statistics data, evaluation of metrics for the segments of the website statistics data, and generation of the corresponding analytics data. The processing may also include applying rules against the website statistics data, with the rules being selected from the database 135 and associated with the semantic model.

In operation 308, the website analytics data is communicated to the VAI 120 via the AI chatbot 123. Such communication is performed at the API level. In operation 310, the AI chatbot 123 converts the website analytics data into a natural language format for delivering to the user.

Additionally, the method 300 may involve identifying abnormalities, incidents, or other events in the generic data and/or analytics data, and sending enquiries to specific users based on the one or more data components of the user profile (for example, a job title). If the users are aware of any information related to the identified abnormalities, they may provide such information, so the method will involve receiving user provided information. The user provided information may be delivered to other users based on the analytics data they are delivered. For example, the user provided information on a specific incident may be provided to the users whose analytics data include data related to the incident. Additionally, while determining the users to receive the user provided information, date ranges related to abnormalities, incidents, or other events and to the user provided information may be considered.

FIG. 3B is a process flow diagram illustrating the computer-implemented method 320 for interactive data delivery, in accordance with different embodiments. The computer-implemented method 320 may commence with receiving user login information during operation 322. For example, a user may enter a user name and password into a user interface to establish the connection. The method 320 may proceed with retrieving a user profile based on the user login information during operation 324. The user profile may include information on a user's industry, user's company, user's role, business objectives, and/or website's goal. The user may provide this information while setting up a user profile, as further described below with reference to FIG. 3C. In the same or other embodiments, the user profile may be built upon previous interactions with the systems. For example, the computer system may include learning features, which track previous requests from the user and retrieves information from these requests to build up the user profile. Furthermore, some portions of the profile may be adapted from various plugins to databases, such as LinkedIn databases, web crawlers, web analytics account information, and other sources of information.

The method 320 may proceed with receiving a user request for a certain type of information during operation 326. For example, a user may choose certain types of data or reports to be displayed or otherwise communicated to the user. A user interface may display one or more reporting options from which a user can choose. These options may be preselected based on the user profile. In certain embodiments, one or more user requests may be automatically retrieved at the time of login into the system.

The method 320 may proceed with retrieving generic data associated with the user request during operation 328. The generic data may be retrieved from one or more web analytics services, such as Google Analytics®, Site Catalyst®, WebTrends®, GoodData®, NetStats®, and the like. The retrieved data may be web analytics data or some other data. In certain embodiments, a user profile includes information for logging into the corresponding web analytics service. Overall, retrieving generic data may be performed using information contained in the user request and/or user profile.

In certain embodiments, the computer-implemented method 320 also involves transmitting a request to a remote data source based on the user login information and/or the user request and receiving a response from the remote data source containing the generic data, as shown by block 327. The remote data source may be one of the web analytics services listed above, a database, or some other source of data. The request transmitted to the remote data source may include authorization information in order for the remote data source to release the required information. For example, a user may have an account with one or more web analytics services. The computer-implemented method provided herein may be able to automatically login into these accounts (e.g., through a corresponding API) using information available to the computer system on which this method is implemented.

Once the generic data is retrieved or otherwise becomes available at the system (e.g., during some previous retrieval sessions), the method 320 may proceed with processing the retrieved generic data to generate analytics data during operation 330. This processing operation 330 may be based on the user profile retrieved during operation 324. The analytical data generated during this operation is specific to user-defined parameters. As such, even if the same generic data is retrieved for different users, the analytics data generated for these users will be different. One user (e.g., an executive) may be interested in an overview. Another user may be interested in a specific subset of the data specific to his or her job.

In certain embodiments, processing the retrieved generic data to generate the analytics data during operation 330 involves fitting the retrieved generic data into one or more predetermined templates. This fitting operation may be based on one or more scoring factors associated with the user profile. For example, one user may be more interested in distinguishing between new visitors and returning visitors, counting a total number of visits, identifying unique visitors, determining time spent viewing a webpage, determining bouncing rate, determining type of browsers used, determining operating systems, and/or other parameters. The one or more scoring factors may include a sell product category, leads generation category, provide information category, create online community category, sustaining current customers category, and/or recruiting affiliates category.

In certain embodiments, one or more values associated with the one or more scoring factors are selected based on the one or more data components of the user profile. A user may assign particular interest levels to various scoring factors listed above. Specifically, one user may be more interested in determining time spent viewing a webpage, such as publisher whose revenues are based on providing advertisement content. Another user may be more interested in a number of followers and may be particularly interested in distinguishing between new visitors and returning visitors and/or counting a total number of visits.

In certain embodiments, at least a part of the user request is received in a natural language format. A user may provide a voice input, which is then translated into corresponding commands. The natural language format enhances interactivity aspects of the computer-implemented method and may be easier to use than conventional type-and-read methods and systems. To implement the natural language format, the computer system may include a library of terms that may be used in such requests. In the same or other embodiments, at least a part of the analytics data is delivered in a natural language format.

At some point, the method 320 may involve delivery of the analytics data to the user during operation 328. During this operation, the analytics data may be displayed on a user interface, provided in voice output, sent as a file or message to the user, and/or delivered according to some other methods. The computer-implemented method 320 may also involve repeating receiving a user request and delivering analytics data to the user as shown by the decision block 332. For example, a user may request different kinds of data or different presentation formats. In certain embodiments, these operations are repeated without retrieving additional generic data.

FIG. 3C is a process flow diagram illustrating method 350 for setting up a user profile, in accordance with different embodiments. The method 350 may involve receiving user login information during operation 352. As explained above, the login information may include user information and a password. This information is used as a pointer to various other data contained in the user profile for this particular user. The method may proceed with obtaining one or more data components, such as user industry, company, user role, business objective, and/or website goal during operation 354. Other types of data may be used as well. For example, a user may choose his or her industry, position of the company within the chosen industry, user's role within the company, and other information that may be used by the system to, for example, prepopulate a scoring table. This information will be later used to process the generic data. The method 350 also involves associating the user login information with these data components during operation 356.

In certain embodiments, the method 350 involves obtaining one or more scoring factors for the one or more data components associated with the user login information during 358. Each of the one or more scoring factors may represent an importance of the corresponding data component of the one or more data components to the user. The system may suggest values of the scoring factors based on the information provided to the system during operation 354.

In certain embodiments, the computer-implemented method 350 also involves receiving one or more pointers for retrieving generic data and associating the login information with the one or more pointers during operation 360. For example, a user may have one or more web analytics accounts that he or she may want to use for retrieving the generic data. The user may provide this information into the system, so that the system can retrieve this information on behalf of the user.

The method 350 may also involve generating one or more reporting templates for presenting retrieved generic data during operation 362. The one or more reporting templates may be generated based on the one or more scoring factors provided during operation 358. These templates may be used to fit generic data to make it more understandable to the user.

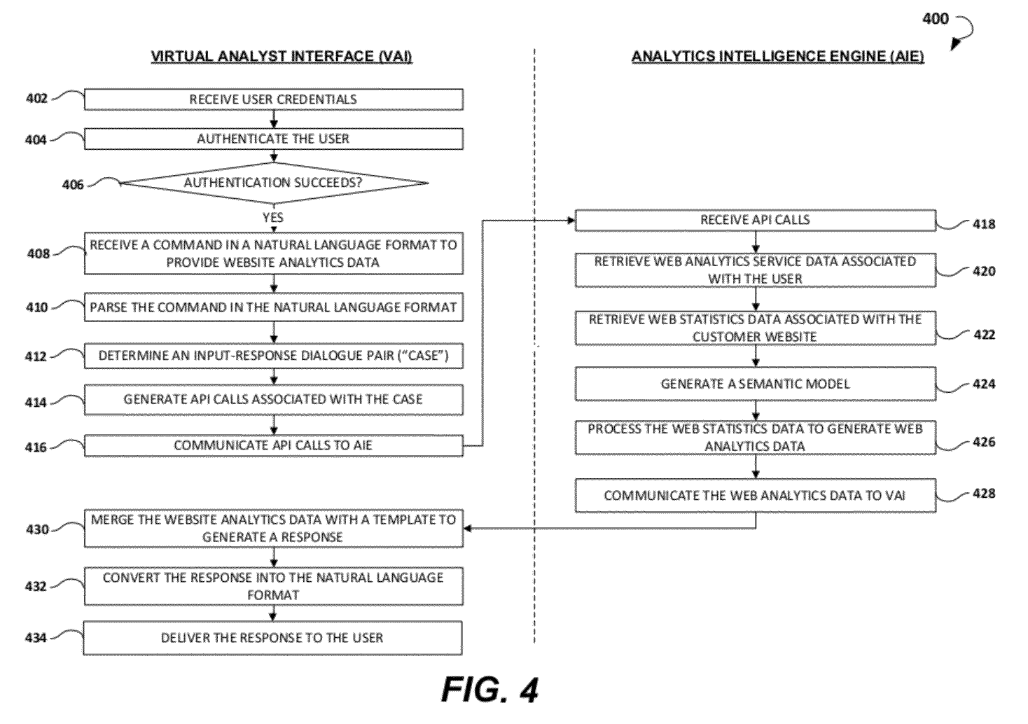

FIG. 4 is a process flow diagram illustrating a further method 400 for the interactive delivery of website analytics data, in accordance with an example embodiment. Although FIG. 4 shows the delivery of website analytics data, those skilled in the art would understand that any other business analytics data can be delivered. The method 400 can be performed by processing logic that can comprise hardware (e.g., dedicated logic, programmable logic, and microcode), software (such as software run on a general-purpose computer system or a dedicated machine), or a combination of both. In one example embodiment, the processing logic resides at the web platform 110, illustrated in FIG. 1. The method 400 can be performed by the various modules discussed above with reference to FIGS. 2A and 2B. Each of these modules can comprise processing logic.

As shown in FIG. 4, the method 400 may commence at operation 402, when the VAI 120 receives user credentials. The VAI 120 can then authenticate the user credentials at operation 404. At operation 406, it can be determined whether the user is a valid customer associated with a customer website to be analyzed. If the VAI 120 cannot authenticate the user as a valid customer, the process may be aborted. If, on the other hand, the user is authenticated as the customer, the VAI 120 proceeds to operation 408, at which a user command in a natural language format is received. The command can be a voice or text based command received via the user interface 121. The user command is associated with the need to provide website analytics data.

In operation 410, the AI chatbot 123 parses the command in the natural language format and generates a machine-readable corresponding equivalent. At operation 412, the management module 124 (or the AI chatbot 123) determines a case (an input-response dialogue pair) associated with the received command.

In operation 414, the AI chatbot 123 generates one or more API calls associated with the case, and, at operation 416, the API calls are communicated to the AIE 130.

In operation 418, API calls are received by the API 133 of the AIE 130, and may optionally be converted in another software code understandable within the AIE 130. Based on the received API calls, at operation 420, the management module 134 retrieves website analytics service data (such as account data (company size, industry sector, geography, preferences, settings, and other configurations) and/or corresponding rules for further data processing). At the next operation 422, the management module 134 requests that the retrieving module 131 retrieve website statistics data from a corresponding remote system or service.

In operation 424, the processing module 132 generates a semantic model based on the case and retrieved website statistics data. The semantic model may comprise concepts and an ontology, and may define a specific set of rules for further processing of the website statistics data to generate analytics data addressing specific needs of the user in accordance with the user's preferences.

In operation 426, the processing module 132 processes the retrieved website statistics data to generate website analytics data (as described above). The processing may be based on applying the rules defined by the semantic model. The website analytics data is then communicated to the VAI 120 at operation 428. Such communication is conducted via the API 133 and the AI chatbot 123.

Upon receiving of the website analytics data by the AI chatbot 123, the management module 124 at the next operation 430 merges the website analytics data with a template to generate a response to the user. The template is associated with the case determined in operation 412.

In operation 432, the response is converted into the natural language format by the AI chatbot 123. At operation 434, the response is delivered to the user via the user interface 121 in the audio, video, image, or text form.

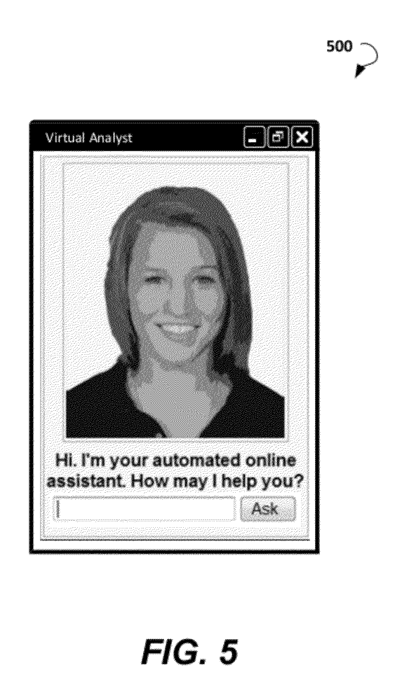

FIG. 5 illustrates a user interface 500, according to an example embodiment. The user interface may be represented as a window (e.g., browser window) having an avatar appearance and an input field for alphanumeric inputs. Those skilled in the art would understand that many possible implementations of the user interface could be applied.

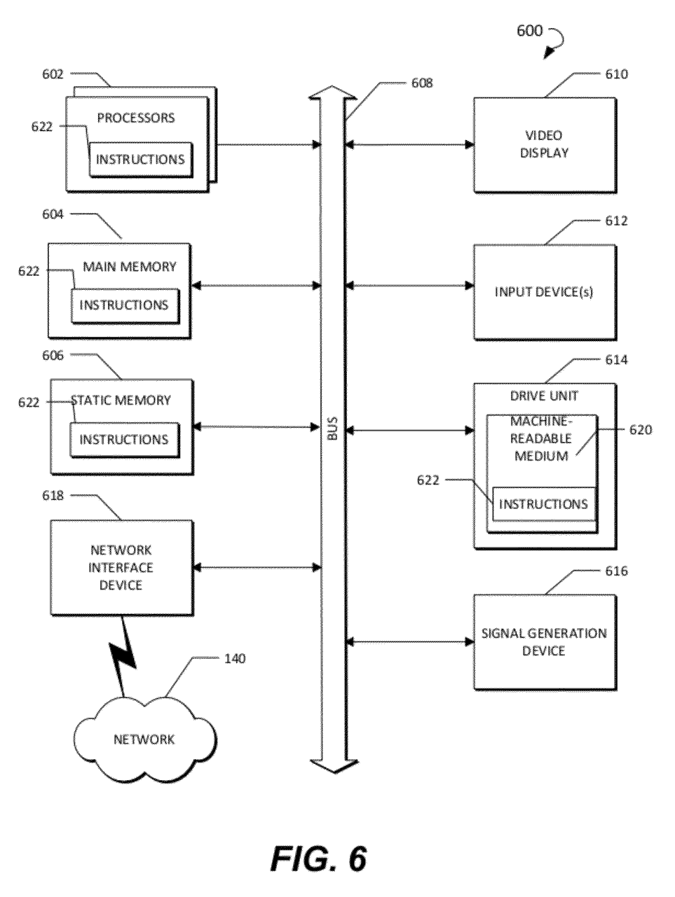

FIG. 6 shows a diagrammatic representation of a computing device for a machine in the example electronic form of a computer system 600, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple engines 602 (e.g., a central processing unit (CPU), a graphics processing unit (GPU), or both), and a main memory 604 and a static memory 606, which communicate with each other via a bus 608. The computer system 600 can further include a video display unit 610 (e.g., a liquid crystal display (LCD) or a cathode ray tube (CRT)). The computer system 600 also includes at least one input device 612, such as an alphanumeric input device (e.g., a keyboard), a cursor control device (e.g., a mouse), a microphone, and so forth. The computer system 600 also includes a disk drive unit 614, a signal generation device 616 (e.g., a speaker), and a network interface device 618.

The disk drive unit 614 includes a computer-readable medium 620 on which is stored one or more sets of instructions and data structures (e.g., instructions 622) embodying or utilized by any one or more of the methodologies or functions described herein. The instructions 622 can also reside, completely or at least partially, within the main memory 604 and/or within the engines 602 during execution thereof by the computer system 600. The main memory 604 and the engines 602 also constitute machine-readable media.

The instructions 622 can further be transmitted or received over a network 140 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, HTML, Dynamic HTML, XML, Extensible Stylesheet Language (XSL), AIML, Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, a method for the interactive delivery of website analytics data has been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What I claim is:

1. A computer-implemented method for interactive data delivery, the method comprising:
receiving a user login information;
based on the user login information, retrieving a user profile comprising one or more data components selected from the group consisting of a user industry, a user company, a user role, a business objective, and a website goal;
receiving a user request;
retrieving generic data associated with the user request;
processing the retrieved generic data to generate analytics data, the processing being based on the user profile; and
delivering the analytics data to the user.

2. The computer-implemented method of claim 1, wherein processing the retrieved generic data to generate the analytics data comprises fitting the retrieved generic data into one or more predetermined templates based on one or more scoring factors associated with the user profile.

3. The computer-implemented method of claim 2, wherein the one or more scoring factors are selected from the group consisting of a sell product category, a leads generation category, a provide information category, a create online community category, a sustaining current customers category, and a recruiting affiliates category.

4. The computer-implemented method of claim 2, wherein one or more values associated with the one or more scoring factors are selected based on the one or more data components of the user profile.

5. The computer-implemented method of claim 1, wherein processing the retrieved generic data to generate the analytics data comprises fitting the retrieved generic data into one or more predetermined templates based on one or more keywords received in the user request.

6. The computer-implemented method of claim 1, wherein the retrieved generic data is web analytics data.

7. The computer-implemented method of claim 1, further comprising transmitting a request to a remote data source based on the user login information and/or the user request and receiving a response from the remote data source containing the generic data.

8. The computer-implemented method of claim 1, wherein at least a part of the user request is received in a natural language format.

9. The computer-implemented method of claim 1, wherein at least a part of the analytics data is delivered in a natural language format.

10. The computer-implemented method of claim 1, further comprising repeating operations corresponding to receiving the user request and delivering the analytics data to the user.

11. The computer-implemented method of claim 10, wherein repeating the operations corresponding to receiving the user request and delivering the analytics data to the user is performed without retrieving additional generic data.

12. A computer-implemented method for setting up a user profile, the method comprising:
receiving a user login information;
obtaining one or more data components selected from the group consisting of a user industry, a user company, a user role, a business objective, and a website goal;
associating the user login information with the one or more data components; and
obtaining one or more scoring factors for the one or more data components associated with the user login information, wherein each of the one or more scoring factors represents importance of a corresponding data component of the one or more data components to a user.

13. The computer-implemented method of claim 12, further comprising receiving one or more pointers for retrieving generic data and associating the login information with the one or more pointers.

14. The computer-implemented method of claim 12, further comprising generating one or more templates for presenting retrieved generic data, the one or more templates generated based on the one or more scoring factors.

15. A system for interactive data delivery, the system comprising one or more subsystems, the one or more subsystems comprising:
at least one subsystem to receive a user login information;
at least one subsystem to retrieve a user profile based on the user login information, the user profile comprising one or more data components selected from the group consisting of a user industry, a user company, a user role, a business objective, and a website goal;
at least one subsystem to receive a user request;
at least one subsystem to retrieve generic data associated with the user request;
at least one subsystem to process the retrieved generic data to generate analytics data, the processing being based on the user profile;
at least one subsystem to deliver the analytics data to the user; and
a memory coupled to the one or more processors to store computer-executable instructions.

16. The system of claim 15, wherein the one or more processors are further configured to fit the retrieved generic data into one or more predetermined templates based one or more scoring factors associated with the user profile.

17. The system of claim 16, wherein the one or more scoring factors are selected from the group consisting of a sell product category, a leads generation category, a provide information category, a create online community category, a sustaining current customers category, and a recruiting affiliates category.

18. The system of claim 15, further comprising at least one subsystem to transmit a request to a remote data source based on the user login information and/or the user request and to receive a response from the remote data source containing the generic data.

19. The system of claim 15, further comprising at least one subsystem to receive and process at least a part of the user request as received in a natural language format.
